(19) United States
(12) Patent Application Publication
(10) Pub. No.: US 2008/0046861 A1
(43) Pub. Date: Feb. 21, 2008

(54) Method and interface for creating a workbook to implement a business process

(76) Inventor: Maria A. Grieser, Garland, TX (US)

Correspondence Address: BAKER BOTTS L.L.P., 2001 ROSS AVENUE, SUITE 600, DALLAS, TX, 75201-2980, US

(21) Appl. No.: 11/505,123

(22) Filed: Aug. 15, 2006

(51) Int. Cl. G06F 9/44

(52) U.S. Cl. 717/104

(57) ABSTRACT

An interface and method for creating a workbook to implement a business process includes creating a program worksheet that includes a plurality of command lines. Each command line has a plurality of cells arranged in a grid layout. A selection of a category in a function cell of a command line is received. Functions associated with the selected category in the function cell are displayed, and a selection of a function in the function cell is received. An argument associated with the selected function in an argument cell of the command line is displayed.

### TECHNICAL FIELD

This invention relates generally to the field of programming and more specifically to a method and an interface for creating a workbook to implement a business process.

### BACKGROUND

Off-the-shelf applications leave process gaps that require customization of the application to document and implement business processes. For example, a company purchasing an off-the-shelf application may need to, configure the purchased application to apply specific business rules of the company. Traditional processes used to customize the application are time-intensive, or even further, require reliance on manual means to handle processes.

### SUMMARY OF THE DISCLOSURE

In accordance with the present invention, disadvantages and problems associated with previous techniques for customizing an application to implement business processes may be reduced or eliminated.

According to one embodiment of the present invention, an interface and method for creating a workbook to implement a business process includes creating a program worksheet that includes a plurality of command lines. Each command line has a plurality of cells arranged in a grid layout. A selection of a category in a function cell of a command line is received. Functions associated with the selected category in the function cell are displayed, and a selection of a function in the function cell is received. An argument associated with the selected function in an argument cell of the command line is displayed.

Certain embodiments of the invention may provide one or more technical advantages. A technical advantage of one embodiment includes providing a user-friendly environment in which to program. For example, the programming environment standardizes functions for business processes. Another technical advantage of an embodiment includes using a grid layout in which to program, which also supports the user-friendliness of the environment. The grid layout allows for easily reviewing, verifying, modifying, and/or maintaining business processes. Yet another technical advantage of an embodiment includes automating processes that document and implement business rules upon customizing the application using the programming environment. The programming environment allows for the creation of a more accurate, faster, and automated analysis environment.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a system for customizing an application to implement a business process;

FIG. 2 is a screen shot illustrating an embodiment of a graphical user interface for executing a workbook to implement the business process;

FIG. 3 is a screen shot illustrating an embodiment of the interface for creating the workbook to implement the business process;

FIG. 4 is a screen shot illustrating another embodiment of the interface for creating a program worksheet;

FIG. 5 is a flowchart for creating the workbook that facilitates implementation of the business process; and

FIG. 6 is a flowchart for executing the workbook that facilitates implementation of the business process.

### DETAILED DESCRIPTION OF THE DRAWINGS

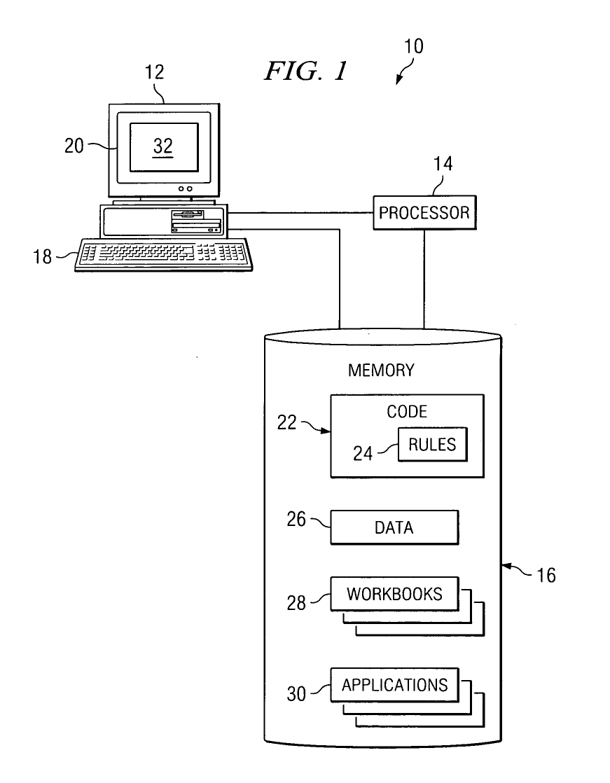

Embodiments of the present invention and its advantages are best understood by referring to FIGS. 1 through 6 of the drawings, like numerals being used for like and corresponding parts of the various drawings.

FIG. 1 is a block diagram illustrating a system 10 for customizing an application to implement a business process. Business rules may be used to implement the business process. For example, system 10 uses the business rules to generate status reports, financial reports, sales reports, manufacturing reports, quality reports, or any suitable report for use in organizations. As another example, system 10 sends electronic messages, logs manufacturing processes, handles scheduling, or performs any automated function. System 10 includes a controller 12, a processor 14, and a memory 16, and an input device 18. Users interact with input device 18 and display 20 of controller 12 to document and implement business processes. Using input device 18, display 20, code 22, and data 26, the user creates workbooks 28 that interact with applications 30.

Controller 12 communicates information between a user, processor 14, and memory 16. Controller 12 represents any appropriate hardware and/or software capable of facilitating communication between components of system 10. In an embodiment, controller 12 communicates information between one or more interconnected components in a network. In some embodiments, controller 12 includes a personal computer or a laptop computer.

Processor 14 controls the operation and administration of system 10. For example, processor 14 processes information and/or commands received from display 20 and memory 16. Processor 14 includes any hardware and/or software that operate to control and process information. For example, processor 14 is a microcontroller, a programmable logic device, a microprocessor, any suitable processing device, or any combination or number of the preceding. In an embodiment, processor 14 is a central processing unit (CPU) of a personal computer. In another embodiment, processor 14 is distributed among components of system 10.

Memory 16 stores, either permanently or temporarily, data and other information accessible by controller 12, processor 14, and display 20. Memory 16 includes any one or a combination of volatile or nonvolatile local or remote devices suitable for storing information. For example, memory 16 includes random access memory (RAM), read only memory (ROM), magnetic storage devices, optical storage devices, or any other suitable information storage device or combination of these devices. Memory 16 stores information in one or more modules. For example, in the illustrated embodiment, memory 16 includes code 22, rules 24, data 26, workbooks 28, and applications 30. While memory 16 as illustrated includes particular modules, memory 16 maintains any suitable information for use in operation of controller 12.

Input device 18 represents any suitable input device, such as a keyboard, a touch screen, a microphone, or other suitable input device. Inputs received from a user using input device 18 may appear on display 20.

Display 20 displays information to users of controller 12. Display 20 also facilitates communication between a user and other components within system 10. In an embodiment, display 20 includes a graphical user interface 32 for interaction with a user. Display 20 may include any suitable information to facilitate a user-friendly programming environment and provides for customizing applications 30.

Code 22 represents a set of instructions executed by processor 14. Code 22 may include any form of logic, hardwired instructions, hardware, and/or software. Code 22, when executed, controls the operation of controller 12. For example, code 22 includes logic that presents information to a user for customizing applications 30 through interface 32. Code 22 also includes executable files capable of automatically processing data 26 using rules 24 or processing data 26 using rules 24 upon receiving an external command. As another example, code 22 includes rules 24 that facilitate the review and/or manipulation of data 26. Rules 24 include any suitable information that constrains or defines the review and/or manipulation of data 26.

Data 26 includes any suitable information for use by code 22, rules 24, and applications 30 and for use in workbooks 28. For example, data 26 includes information about individuals in an organization, such as name and address. As another example, data 26 may include information about work in the organization, such as total sales attributed to each individual. Using data 26, a user customizes applications 30 through display 20. A user may enter data 26 initially upon programming or data 26 may be populated as the processes execute.

Workbooks 28 provide for customizing applications 30 to handle a particular process. Workbook 28 includes any suitable information to affect a process that interacts with applications 30. For example, workbook 28 includes a program worksheet that describes a particular program to implement using application 30. As another example, workbook 28 includes several program worksheets that facilitate the generation of reports for analysis. In an embodiment, each workbook 28 includes a log file that records the execution of a program worksheet associated with workbook 28. One particular embodiment is arranged similar to a Microsoft® Excel® spreadsheet, but system 10 contemplates any suitable arrangement or organization that allows for the generation and execution of business processes using a grid layout. As another example, workbook 28 is available in Oracle®, Microsoft® Structured Query Language (SQL) Server, Microsoft® Access, Microsoft® Visual Basic®, dBASE™, or mySQL®.

Applications 30 include any suitable software program that carries out a process. For example, applications 30 include spreadsheets, communication packages, graphic programs, word processing programs, databases, and scheduling programs. Workbooks 28 interact with applications 30 to provide a customizable and automated system for handling processes. For example, using workbooks 28, a user may execute and configure multiple applications 30 in a particular sequence to perform one or more business processes.

Modifications, additions, or omissions may be made to system 10. For example, controller 12 may use any suitable information to customize applications 30 in addition to rules 24, data 26, and workbooks 28. The arrangement of components in system 10 may be configured in any suitable manner to facilitate the user-friendly programming environment. As another example, the functions of system 10 may be performed in one or more components of system 10. Any suitable logic comprising software, hardware, other logic, or any suitable combination of the preceding may perform the functions of any component in system 10.

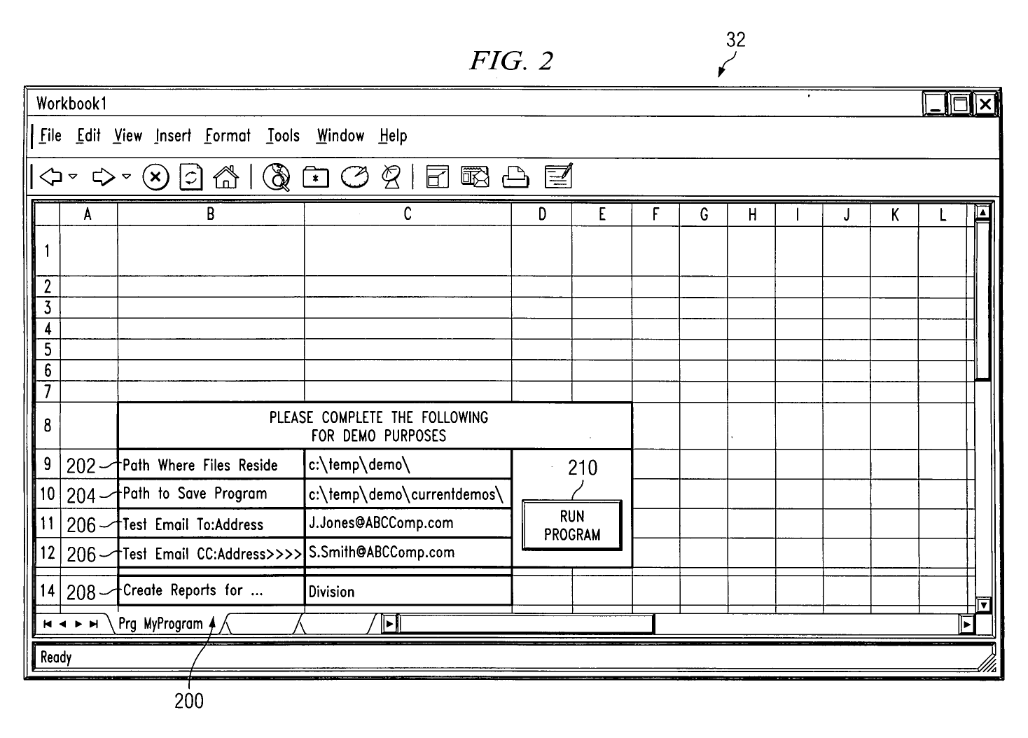

FIG. 2 is a screen shot illustrating an embodiment of a graphical user interface 32 for executing a workbook 28 to implement the business process. Interface 32 includes an execution worksheet 200 that provides for executing workbook 28 created using system 10. Any suitable execution worksheet 200 may be used to execute workbook 28. As another example, workbook 28 may execute automatically without using execution worksheet 200. A user that desires to execute workbook 28 to perform business processes may access and modify this top-level execution worksheet 200 without having to access or modify other underlying portions of code 22, data 26, and workbook 28 that implement the business processes.

In the illustrated embodiment, execution worksheet 200 includes an origination cell 202, a destination cell 204, one or more electronic mail (email) cells 206, a report cell 208, and an execution button 210. Origination cell 202 includes the path of the file to access the data to utilize the program. For example, the files to execute in the illustrated embodiment may be found at c:\temp\demo\. Destination cell 204 includes a path to which to save the results of the executed program. For example, the files to execute are saved to c:\temp\demo\currentdemos\.

Email cells 206 include the email addresses to send the results of the executed workbook 28. For example, email cells 206 include a primary email address, a carbon copy (cc) email address, and/or a blind cc email address. Email cells 206 may include any suitable email address in any suitable domain. For example, email cells 206 may include email addresses within the organization's domain.

Report cell 208 includes for whom to create the executed report. For example, when workbook 28 is executed, a report may be created according to the workbook 28. In the illustrated embodiment, a report is created for a division.

In operation, a user inputs or software inputs information into origination cell 202, destination cell 204, email cell 206, and report cell 208. When execution worksheet 200 includes the information, the user or the software implements the execution of the program by pressing execution button 210. A user may press execution button 210 to begin the execution of workbook 28. Execution button 210 may be any suitable shape and include any suitable text to facilitate the execution of workbook 28.

Modifications, additions, or omissions may be added to execution worksheet 200 on interface 32. For example, execution worksheet 200 may include a single email cell 206 rather than multiple email cells 206. The arrangement of elements in execution worksheet 200 may be configured in any suitable manner to facilitate the user-friendly environment. Any suitable logic comprising software, hardware, other logic, or any suitable combination of the preceding may perform the functions of any elements in execution worksheet 200.

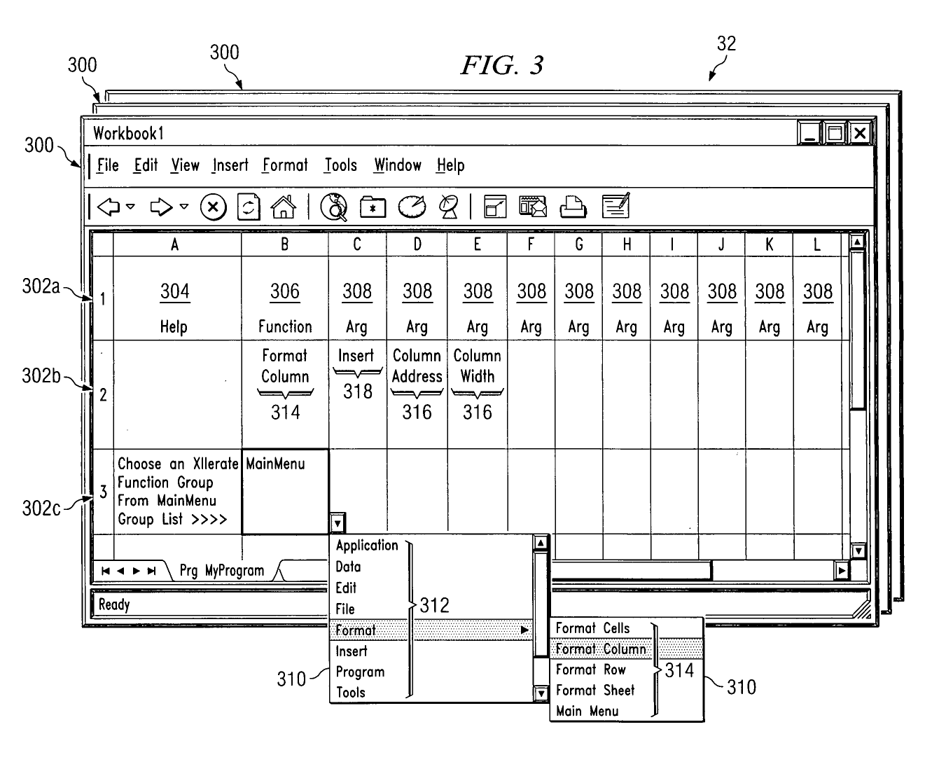

FIG. 3 is a screen shot illustrating an embodiment of interface 32 for creating workbook 28 to implement the business process. Interface 32 includes one or more program worksheets 300 that provide for a user-friendly programming environment. Workbook 28 includes an execution worksheet 200 and one or more program worksheets 300. Memory 16 stores workbook 28 for retrieval.

Each program worksheet 300 has a grid layout, such as a spreadsheet, that further facilitates programming. Program worksheets 300 may be created in any suitable program that supports the grid layout. The grid layout includes a plurality of rows and a plurality of columns arranged in a suitable grid. For example, program worksheets 300 may be created in any suitable application 30, such as Microsoft® Excel®, Oracle®, Microsoft® SQL Server, Microsoft® Access, Microsoft® Visual Basic®, dBASE™, or mySQL®. Program worksheet 300 may utilize a toolset of application 30 in which it was developed.

Within the grid, program worksheet 300 includes a plurality of command lines 302 to facilitate entry of programming commands by a user. Each command line 302 includes a plurality of cells. The cell represents a particular column in a particular row. In the illustrated embodiment, each command line 302 includes a help cell 304, a function cell 306, and one or more argument cells 308. The identification of the particular cells may be included in the first command line 302a of program worksheet 300.

Help cell 304 provides information to assist the user in programming command line 302. Help cell 304 may be in any suitable form, such as a hyperlink, a drop-down menu, or a command field. For example, help cell 304 may be generated with appropriate information when function cell 306 receives a function selection. Help cell 304 provides any suitable information to facilitate programming. For example, in command line 302c, help cell 304 includes information that prompts the user to make a selection.

Function cell 306 provides categories 312 to program processes for system 10 to implement. Function cell 306 provides any suitable programming category for selection. For example, function cell 306 includes the following available categories 312: applications, data, edit, file, format, insert, program, and tools. Function cell 306 may display categories 312 in any suitable manner. For example, function cell 306 includes the programming categories 312 in a drop-down menu 310. In the illustrated embodiment, command line 302c illustrates an example of categories 312 in drop-down menu 310 and the format category 312 is selected. As another example, categories 312 may be selected using hot keys.

In an embodiment, each category 312 includes associated programming functions 314. Function cell 306 includes functions 314 associated with selected category 312. For example, the selected format category 312 includes the following functions 314: format cells, format column, format row, and format sheet. Function cell 306 may display functions 314 associated with selected category 312 in any suitable manner. For example, functions 314 appear in a drop-down menu 310 for selection as illustrated in command line 302c. As another example, functions 314 may be selected using hot keys. The format column function 314 is selected in command line 302c. In the illustrated embodiment, command line 302b illustrates a selected function 314. Based on selected function 314, program worksheet 300 may launch applications 30 external to program worksheet 300 and its programming environment. For example, applications category 312 includes functions 314 to launch external applications 30, such as Microsoft® Outlook or Microsoft® Access. Categories and functions are arranged in any particular manner, such as hierarchical drop-down menus, side-by-side expansion menus, or any suitable arrangement.

Argument cells 308 provide arguments 316 associated with the selected function 314 in function cell 306 of the same command line 302. Argument cells 308 include any suitable argument 316 associated with the selected function 314. For example, upon selection of the format column function 314 in command line 302b, the following arguments 316 are automatically generated in separate argument cells 308: column function, column address, and column width. In an embodiment, arguments 316 include available parameters 318 or example parameters 318 for program worksheet 300 to receive. For example, the column function argument 316 has a plurality of available parameters 318, such as auto fit, delete, hide, insert, select, unhide, and width. In the illustrated embodiment, insert is selected as parameter 318 for the column function argument in command line 302b. Interface 32 may present the available parameters 318 in any suitable manner, such as in a drop-down menu 310 for selection or within argument cell 308. If the selected function 314 includes more than one argument 316, each argument 316 is included in a separate argument cell 308 on command line 302. In the illustrated embodiment, command line 302b illustrates exemplary arguments 316 (column address and column width) and an exemplary parameter 318 (insert) associated with the selected exemplary function 314.

In an exemplary embodiment of operation, the user populates program worksheet 300 to perform business processes. On command line 302, a selection of category 312 is received in drop-down menu 310 of function cell 306. Upon the selection of category 312, functions 314 associated with the selected category 312 are automatically generated in drop-drown menu 310. Interface 32 receives a selection of function 314 and automatically generates arguments 316 associated with the selected function 314 in argument cells 308. Interface 32 receives parameters 318 for each argument 316. In an embodiment, information associated with the selected function 314 is generated in help cell 304 to assist the user. Additional command lines 302 in program worksheet 300 may be programmed in a similar manner. Through automated prompts, the population of program worksheet 300 is done automatically, logically, and hierarchically to provide a structured programming environment.

Modifications, additions, or omissions may be made to interface 32 as illustrated in FIG. 3. For example, help topics may be generated in function cell 306 and/or argument cells 308 rather than having a separate help cell 304. As another example, interface 32 may include any suitable number of command lines 302, help cells 304, function cells 306, and argument cells 308. As yet another example, interface 32 may include additional categories 312 and/or functions 314 to facilitate programming. Additionally, interface 32 may include any suitable information in any suitable organization.

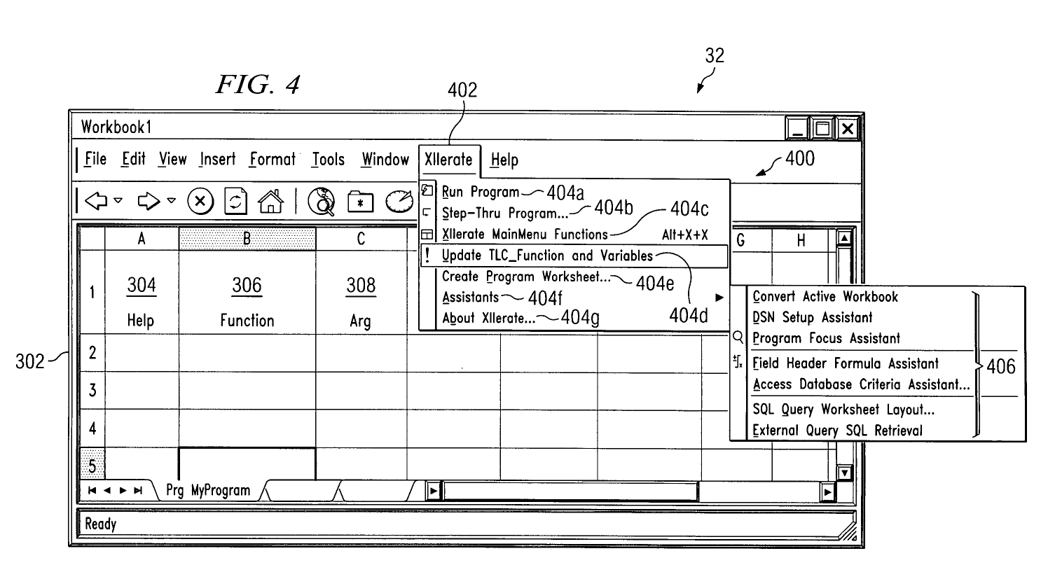

FIG. 4 is a screen shot illustrating another embodiment of interface 32 for creating program worksheet 300. Interface 32 includes an Xllerate™ menu command 402 on toolbar 400. Xllerate™ menu command 402 includes any suitable commands 404 to facilitate implementation of business processes.

In the illustrated embodiment, Xllerate™ menu command 402 includes the following commands: Run Program 404a, Step-Thru Program 404b, Xllerate™ Main Menu Functions 404c, Update TLC_Function and Variables 404d, Create Program Worksheet 404e, Assistants 404f, and About Xllerate™ 404g. Run Program 404a provides for executing a created program worksheet 300. Program worksheet 300 is executed in sequential order. The execution of program worksheet 300 continues until the end of program worksheet 300 is reached. For example, the first blank command line 302 may be considered the end of program worksheet 300. Step-Thru Program 404b provides for cause and effect programming. For example, step-thru program 404b runs a created program worksheet 300 by having each command line 302 implemented one at a time, and the user reviews the results of each implemented command line 302. This command allows the user to see what each function is doing in program worksheet 300. The Xllerate™ Main Menu Functions command 404c provides the categories 312 available when populating program worksheet 300. The Update TLC_Function and Variables command 404d provides for replacing parameters 318 with the generic arguments 316 associated with the selected function 314. Create Program Worksheet 404e provides for the creation of program worksheet 300. In an embodiment, multiple program worksheets 300 are created. The Assistants command 404f helps the user with the development or use of program worksheet 300. In an embodiment, assistants 404f include subcommands 406. For example, assistants 404f include the following subcommands 406: convert active workbook, Data Source Name (DSN) set-up assistant, program focus assistant, field header formula assistant, access database criteria assistant, SQL query worksheet layout, and external query SQL retrieval. About Xllerate™ 404g provides information, such as copyright information, concerning interface 32.

Modifications, additions, or omissions may be made to interface 32 as illustrated in FIG. 4. For example, Xllerate™ menu command 402 may include any suitable type and number of commands 404. As another example, commands 404 may include any suitable type and number of subcommands 406.

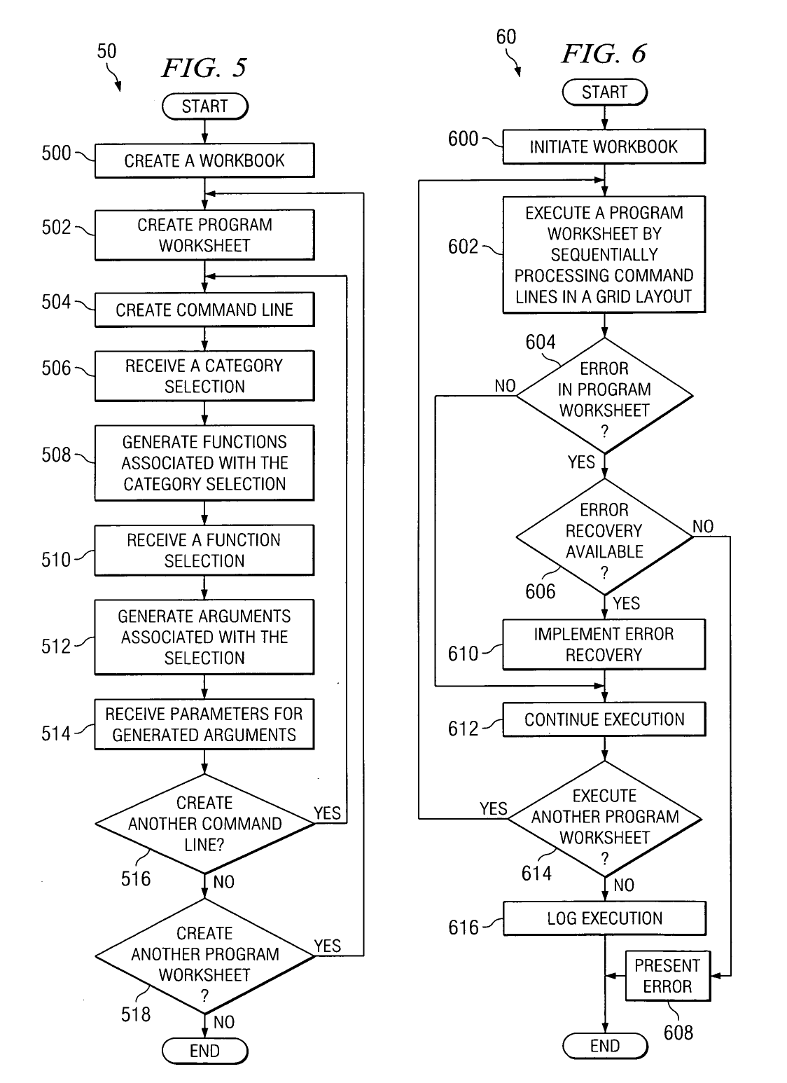

FIG. 5 is a flowchart 50 for creating workbook 28 that facilitates implementation of the business process. A user creates workbook 28 from interface 32 at step 500. At step 502, interface 32 provides for creating program worksheet 300 within the created workbook 28. Program worksheet 300 may be created using any suitable technique. For example, the user selects a Create Program Worksheet command 404e from Xllerate™ menu commands 402 on interface 32.

Upon creating program worksheet 300, the creation process continues at step 504 with the creation of command line 302. Interface 32 receives a selection of category 312 at step 506. For example, interface 32 receives the selection of category 312 in function cell 306. Interface 32 generates functions 314 associated with the selected category at step 508. The generated functions 314 may be displayed in any suitable manner, such as in drop-down menu 310. Interface 32 receives a function 314 selection at step 510. The associated arguments 316 of the selected function 314 are generated at step 512.

Interface 32 receives parameters 318 for the generated arguments 316 at step 514. For example, a user may input parameters 318 into argument cells 308, or parameters 318 may automatically generate based on other selections and inputs. As another example, a user may input wildcards as parameters 318.

Additional command lines 302 may be created. At step 516, interface 32 determines whether to create additional command lines 302. To create additional command lines 302, the method continues from step 504 by creating command line 302. If another command line 302 is not to be created on program worksheet 300, it is determined whether to create another program worksheet 302 within workbook 28 at step 518. To create another program worksheet 300, the method continues from step 502 by creating program worksheet 300. If another program worksheet 300 is not created within workbook 28, the method of creating workbook 28 subsequently ends.

Modifications, additions, or omissions may be made to flowchart 50 in FIG. 5. For example, interface 32 may generate help information associated with the selected function within command line 302. As another example, interface 32 may generate parameter options for each generated argument. A user may select the appropriate parameter 318 from the generated parameter options. As yet another example, interface 32 may provide for automatically determining and generating parameters 318 for each argument 316. As another example, if an error occurs during creation of workbook 28, the error is trapped when an error is recognized. For instance, when a user enters a selection that contains an error, the error is displayed. An example of a suggested selection may be provided, an explanation of the error, or any suitable error trapping. Flowchart 50 may include more, fewer, or other steps. Additionally, steps may be performed in any suitable order and by any suitable component.

FIG. 6 is a flowchart 60 for executing workbook 28 that facilitates implementation of the business process. Workbook 28 is initiated at step 600. For example, a user initiates workbook 28 by depressing a soft button on execution worksheet 200. As another example, an internal mechanism automatically initiates workbook 28. Program worksheet 300 is executed at step 602 by sequentially processing command lines 302 arranged in the grid layout.

At step 604, it is determined whether program worksheet 300 contains an error. For example, program worksheet 300 may contain an error in parameter 318. If program worksheet 300 does not contain an error, program worksheet 300 continues its execution from step 612. If program worksheet 300 contains an error, workbook 28 attempts to recover from the detected error. At step 606, workbook 28 determines whether error recovery is available. If error recovery is not available, workbook 28 presents the detected error at step 608 and the execution of program worksheet 300 ends. On the other hand, if error recovery is available, workbook 28 implements the error recovery at step 610. Error recovery includes any suitable technique that prevents the premature termination of program worksheet 300. As an example, if parameter 318 includes information about a non-existent directory, workbook 28 may create the directory as an error recovery technique. As another example, default recovery techniques may be included to address commonly occurring errors. As yet another example, error recovery may include ignoring the error and continuing execution of program worksheet 300. The execution of program worksheet 300 continues at step 612.

At step 614, it is determined whether workbook 28 includes another program worksheet 300 to execute. If workbook 28 includes another program worksheet 300, the method continues from step 602 by executing the additional program worksheet 300. If workbook 28 does not include another program worksheet 300 to execute, workbook 28 logs the execution of the one or more program worksheets 300 at step 616.

Modifications, additions, or omissions may be made to flowchart 60 in FIG. 6. For example, the logging function of step 616 may be disabled. As another example, logging of the various steps may occur after each step instead of at the completion of the execution of program worksheet 300. As yet another example, external applications 30 may be accessed during execution of program worksheet 300. To access applications 30, program worksheet 300 may launch application 30 or use information from application 30. Flowchart 60 may include more, fewer, or other steps. Additionally, steps may be performed in any suitable order and by any suitable component.

Although the present invention has been described in several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for creating a workbook to implement a business process, comprising:
creating a program worksheet that comprises a plurality of command lines each command line having a plurality of cells arranged in a grid layout;
receiving a selection of a category in a function cell of a command line;
displaying functions associated with the selected category in the function cell;
receiving a selection of a function in the function cell; and
displaying an argument associated with the selected function in an argument cell of the command line.

2. The method of claim 1, further comprising receiving, in the argument cell, a parameter associated with the argument.

3. The method of claim 2, further comprising:
receiving a command to enter a new parameter in the argument cell; and
updating an argument associated with the new parameter.

4. The method of claim 1, further comprising generating, in the argument cell, a parameter associated with the argument.

5. The method of claim 1, further comprising displaying help information in a help cell of the command line.

6. The method of claim 1, further comprising displaying a plurality of categories in a drop-down menu for selection.

7. The method of claim 1, wherein displaying functions associated with the selected category comprises displaying the functions in a drop-down menu for selection.

8. The method of claim 1, further comprising displaying a plurality of arguments in a drop-down menu for selection.

9. The method of claim 1, further comprising:
recognizing an error during creation of the workbook; and
implementing error trapping to provide for correction of the error.

10. A method for executing a workbook to implement a business process, comprising:
initiating a workbook, wherein the workbook comprises a program worksheet; and
executing the program worksheet in the workbook, wherein the program worksheet comprises a plurality of command lines, each command line having a plurality of cells arranged in a grid layout, wherein executing the program worksheet comprises sequentially processing each command line according to an arrangement of the plurality of command lines in the program worksheet.

11. The method of claim 10, wherein sequentially processing each command line comprises:
determining a function in a command line, each function in a function cell of the command line;
determining a parameter associated with the function, each parameter in an argument cell of the command line; and
processing the function in the command line according to the parameter.

12. The method of claim 10, wherein sequentially processing each command line comprises processing each command line comprising a function and a parameter.

13. The method of claim 10, further comprising:
determining whether a command line in the grid layout is blank; and
terminating the execution of the program worksheet if the command line is blank.

14. The method of claim 10, further comprising:
determining if an error occurs during the execution of the program worksheet; and
determining whether error recovery is available if the error occurs.

15. The method of claim 14, further comprising, if the error recovery is available, implementing the error recovery.

16. The method of claim 15, wherein implementing the error recovery comprises applying a default error recovery.

17. The method of claim 14, further comprising:
if error recovery is not available, presenting the error; and
terminating the execution of the program worksheet.

18. The method of claim 10, further comprising:
determining whether the program worksheet uses an external application according to a function and an argument in the command line; and
accessing the external application according to the function and the argument in the command line.

19. The method of claim 10, further comprising logging the execution of the program worksheet.

20. The method of claim 10, further comprising:
determining whether the workbook comprises an other program worksheet; and
executing the other program worksheet if the workbook includes the other program worksheet.

21. The method of claim 10, further comprising initiating the workbook using an execution worksheet, wherein the workbook comprises the execution worksheet.

22. An interface for creating a workbook to implement a business process, comprising:
a plurality of command lines arranged in a grid layout for receiving programming instructions, each command line comprising:
a function cell operable to display a plurality of programming functions and to receive a selection of a programming function; and
an argument cell operable to display an argument associated with the selected programming function and to receive a parameter for the argument displayed.

23. The interface of claim 22, wherein each command line further comprises a help cell operable to display help information associated with the programming function selection.

24. The interface of claim 22, wherein the function cell further comprises a first drop-down menu operable to:
display a plurality of programming categories for selection; and
receive a selection of a programming category.

25. The interface of claim 24, wherein the function cell further comprises a second drop-down menu operable to:
display a plurality of programming functions associated with the selected programming category; and
receive a selection of a programming function.

26. The interface of claim 22, wherein the argument cell further comprises a first drop-down menu operable to:
display a plurality of arguments for selection; and
receive a selection of an argument.

27. The interface of claim of claim 22, wherein a first command line of the plurality of command lines includes a plurality of cells identifying each cell as a selected one of a help cell, a function cell, and an argument cell.

28. The interface of claim 22, further comprising a menu command on a toolbar, the menu command operable to provide programming commands.

29. The interface of claim 22, wherein a plurality of command lines in an application arranged in a grid layout further comprises a plurality of command lines in a spreadsheet.

30. The interface of claim 29, wherein the plurality of command lines in the spreadsheet comprises a plurality of command lines in a Microsoft® Excel® spreadsheet.

31. Logic for creating a workbook to implement a business process, the logic embodied in a medium and operable to:
create a program worksheet that comprises a plurality of command lines each command line having a plurality of cells arranged in a grid layout;
receive a selection of a category in a function cell of a command line;
display functions associated with the selected category in the function cell;
receive a selection of a function in the function cell; and
display an argument associated with the selected function in an argument cell of the command line.

32. The logic of claim 31, the logic further operable to receive, in the argument cell, a parameter associated with the argument.

33. The logic of claim 32, the logic further operable to:
receive a command to enter a new parameter in the argument cell; and
update an argument associated with the new parameter.

34. The logic of claim 31, the logic further operable to generate, in the argument cell, a parameter associated with the argument.

35. The logic of claim 31, the logic further operable to display help information in a help cell of the command line.

36. The logic of claim 31, the logic further operable to display a plurality of categories in a drop-down menu for selection.

37. The logic of claim 31, wherein displaying functions associated with the selected category comprises displaying the functions in a drop-down menu for selection.

38. The logic of claim 31, the logic further operable to display a plurality of arguments in a drop-down menu for selection.

39. The logic of claim 31, the logic further operable to:
recognize an error during creation of the workbook; and
implement error trapping to provide for correction of the error.
